(19) United States
(12) Patent Application Publication
(10) Pub. No.: US 2026/0271135 A1
(43) Pub. Date: Sep. 10, 2026

(54) METHOD AND APPARATUS FOR A WIRELESS COMMUNICATION DEVICE

(71) Applicant: Robert Bosch GmbH, Stuttgart (DE)

(72) Inventors: Marie-Theres Suer, Braunschweig (DE); Maximilian Stark, Hamburg (DE); Sebastian Lindner, Hamburg (DE)

(21) Appl. No.: 19/537,787

(22) Filed: Feb. 12, 2026

(30) Foreign Application Priority Data
Mar. 5, 2025 (DE) 10 2025 108 384.3

(51) Int. Cl. H04W 84/12; H04L 1/00; H04W 72/542

(52) U.S. Cl. CPC H04W 84/12; H04L 1/0026; H04W 72/542

(57) ABSTRACT

A method or a wireless communication device configured to use at least one channel for information exchange with at least one further device. The method includes providing first information that characterizes, for each channel of a plurality of channels, a respective probability distribution of each channel for at least one quality category and a confidence associated with the at least one quality category; determining whether to perform channel switching, e.g., from a current channel to another channel, based at least on the first information; and optionally, performing channel switching based on the determining.

### CROSS REFERENCE

The present application claims the benefit under 35 U.S.C. § 119 of Germany Patent Application No. DE 10 2025 108 384.3 filed on Mar. 5, 2025, which is expressly incorporated herein by reference in its entirety.

### FIELD

The present disclosure relates to a method for a wireless communication device.

The present disclosure further relates to an apparatus for a wireless communication device.

### SUMMARY

Some examples of the present disclosure relate to a method, for example a computer-implemented method, for a wireless communication device configured to use at least one channel for information exchange with at least one further device, comprising: providing first information that characterizes, for each channel of a plurality of channels, a respective probability distribution of each channel for at least one quality category and a confidence associated with the at least one quality category, determining whether to perform channel switching, e.g., from a current channel to another channel, based at least on the first information, and, optionally, performing channel switching based on the determining. In some examples, this may enable to improve a reliability of wireless communication.

In some examples, the at least one channel may, e.g., characterize frequency resources, e.g., in the form of a frequency channel.

In some examples, the wireless communication device may be a wireless communication device for a Wi-Fi system, e.g., based on at least one communication standard such as, e.g., IEEE 802.11. Note, however, that the principle of the disclosure is not limited to Wi-Fi systems, but may rather also be applied to other wireless communication systems involving switching of one or more channels.

In some examples, the Wi-Fi system may, e.g., comprise one or more wireless communication devices configured to transmit and/or receive data over one or more wireless channels, e.g., using radio frequency technology based on the IEEE 802.11 standards. In some examples, the Wi-Fi system may, e.g., comprise one or more access points and one or more client devices capable of establishing connections, managing data transmission, and facilitating communication within a local network or, e.g., extending to broader network infrastructures.

In some examples, providing the first information may comprise at least one of: a) receiving the first information, e.g., from at least one further device, or b) determining the first information, e.g., locally, e.g., within an apparatus configured to perform at least one aspect of the method of the disclosure and/or within the wireless communication device.

In some examples, performing the channel switching may comprise: a) if the determining yields that channel switching should be performed, switching a channel from a current channel to another channel, or b) if the determining yields that channel switching should not be performed, not switching, e.g., omitting to switch, e.g., refraining from switching, the current channel.

In some examples, the method comprises: maintaining, e.g., storing, second information characterizing historic channel switching decisions, performing the determining whether to perform channel switching also based on the second information. In some examples, this may, e.g., enable to prevent oscillatory behavior regarding channel switching.

In some examples, the method comprises: maintaining, e.g., storing, third information characterizing at least one threshold value characterizing at least one acceptable quality category, e.g., channel quality category, performing the determining whether to perform channel switching also based on the third information. In some examples, this enables to determine channels that are acceptable, e.g. for use as candidate for future channel switching.

In some examples, the at least one quality category is associated with at least one performance indicator, for example a key performance indicator, such as, e.g., a packet error rate, PER.

In some examples, the method comprises: maintaining, e.g., storing, fourth information characterizing a plurality of candidate channels for the performing of the channel switching, performing the determining whether to perform channel switching also based on the fourth information.

In some examples, the method comprises: determining the fourth information, and, optionally, organizing the fourth information in form of at least one of: a) a list, or b) a table.

In some examples, the determining of the fourth information comprises: comparing the probability distribution of a specific channel with a predetermined reference distribution, e.g., a uniform distribution, assigning the specific channel to the plurality, e.g., adding the specific channel to the list, of candidate channels based on the comparison, if the comparison indicates that a difference between the probability distribution of the specific channel and the predetermined reference distribution exceeds a predetermined threshold.

In some examples, the method comprises at least one of: a) considering candidate channels, e.g., only candidate channels, for the performing of the channel switching, or b) performing the channel switching only if a quality category of a current channel is not acceptable, e.g., as compared to a predetermined threshold and if a candidate channel with a better quality category is available, e.g., comprised by the fourth information, e.g., comprised in the list and/or table, or c) choosing a candidate channel with a highest classification probability, e.g., if several candidate channels with a better quality category are available, or d) determining, e.g., based on the second information, whether a candidate channel has been chosen for channel switching before, or e) determining, e.g., based on the second information, whether a channel switching pattern is observable, e.g., for a predetermined number N, N>1, of preceding channels, or f) if a or the a channel switching pattern is observable, choosing a best candidate channel of the observed channel switching pattern, and, optionally, keeping the best candidate channel of the observed channel switching pattern, e.g., until a candidate channel that is not part of the observed channel switching pattern, becomes the best candidate channel.

In some examples, the method comprises at least one of: a) signaling that no better channel is available, e.g., if all candidate channels are worse than a current channel, or b) signaling that, e.g., further, scanning, e.g., for potential candidate channels, should be performed, e.g., if the current channel is not acceptable and/or if there are no candidate channels for channel switching, e.g., if the list of candidate channels is empty.

Some examples relate to an apparatus for a wireless communication device that is configured to use at least one channel for information exchange with at least one further device, wherein the apparatus is configured to perform the method according to the present disclosure.

Some examples relate to an access point for a wireless communication system, e.g., a Wi-Fi-System, comprising at least one apparatus according to the present disclosure.

Some examples relate to a client for a wireless communication system, e.g., a Wi-Fi-System, comprising at least one apparatus according to the present disclosure.

Some examples relate to a wireless communication system, e.g., a Wi-Fi-System, comprising at least one of the following elements: a) an apparatus according to the disclosure, or b) an access point according to the disclosure, or c) a client according to the present disclosure.

Some examples relate to a computer program comprising instructions which, when the program is executed by a computer, cause the computer to carry out the method according to the present disclosure.

Some examples relate to a computer-readable storage medium comprising instructions which, when executed by a computer, cause the computer to carry out the method according to the present disclosure.

Some examples relate to a data carrier signal carrying and/or characterizing the computer program according to the present disclosure.

Some examples relate to a use of the method according to the disclosure and/or of the apparatus according to the disclosure and/or of the access point according to the disclosure and/or of the client according to the disclosure and/or of the wireless communication system according to the disclosure and/or of the computer program according to the disclosure and/or of the computer-readable storage medium according to the disclosure and/or of the data carrier signal according to the disclosure for at least one of the following elements: a) channel switching, or b) improving a quality of service, or c) enable wireless communications, e.g., for latency-critical applications, or d) determining candidate channels, or e) increasing a reliability of the wireless communication.

### BRIEF DESCRIPTION OF THE DRAWINGS

Some example embodiments will now be described with reference to the figures.

FIG. 1 schematically depicts a simplified flow-chart, according to an example embodiment.

FIG. 2 schematically depicts a simplified block diagram, according to an example embodiment.

FIG. 3 schematically depicts a simplified flow-chart, according to an example embodiment.

FIG. 4 schematically depicts a simplified flow-chart, according to an example embodiment.

FIG. 5 schematically depicts a simplified flow-chart, according to an example embodiment.

FIG. 6 schematically depicts a simplified flow-chart, according to an example embodiment.

FIG. 7 schematically depicts a simplified flow-chart, according to an example embodiment.

FIG. 8 schematically depicts a simplified flow-chart, according to an example embodiment.

FIG. 9 schematically depicts a simplified block diagram, according to an example embodiment.

FIG. 10 schematically depicts a simplified block diagram, according to an example embodiment.

FIG. 11 schematically depicts example aspects of usen according to the present disclosure.

### DETAILED DESCRIPTION OF EXAMPLE EMBODIMENTS

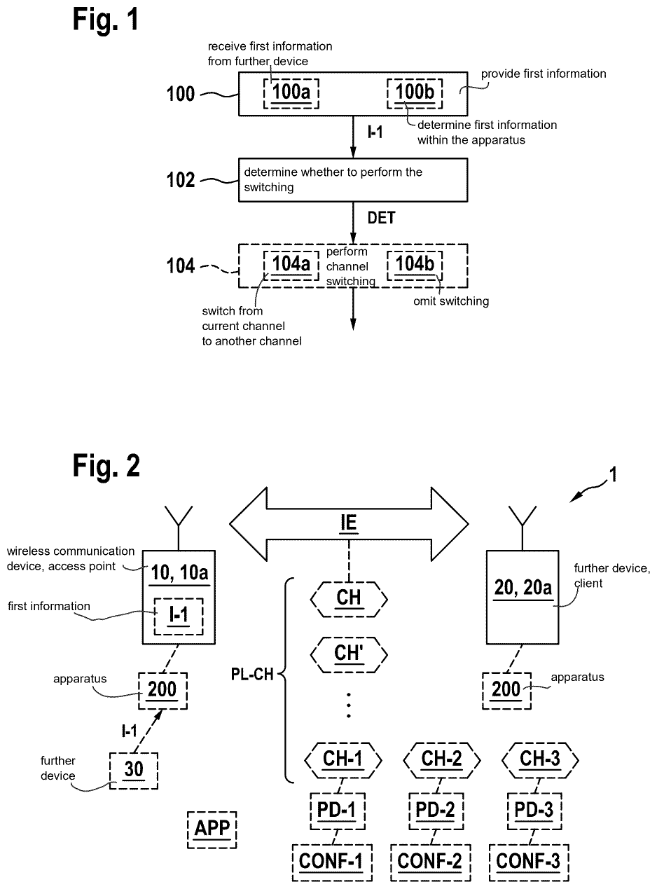

Some examples, see, for example, FIGS. 1, 2, relate to a method, for example a computer-implemented method, for a wireless communication device 10 configured to use at least one channel CH for information exchange IE with at least one further device 20, comprising: providing 100 first information I-1 that characterizes, for each channel CH-1, CH-2, CH-3, . . . of a plurality PL-CH of channels, a respective probability distribution PD-1, PD-2, PD-3, . . . of each channel for at least one quality category and a confidence CONF-1, CONF-2, CONF-3, . . . associated with the at least one quality category, determining 102 whether to perform channel switching, e.g., from a current channel CH to another channel CH′, based at least on the first information I-1, wherein, for example, a respective determination DET may be obtained, and, optionally, performing 104 channel switching based on the determining 102 or determination DET. In some examples, this may enable to improve a reliability of wireless communication.

In some examples, the at least one channel CH, CH′, . . . may, e.g., characterize frequency resources, e.g., of a wireless communication system 1, e.g., in the form of a frequency channel.

In some examples, FIG. 2, the wireless communication device 10 may be a wireless communication device for a Wi-Fi system 1, e.g., based on at least one communication standard such as, e.g., IEEE 802.11.

In some examples, FIG. 1, providing 100 the first information I-1 may comprise at least one of: a) receiving 100a the first information I-1, e.g., from at least one further device 30 (FIG. 2), or b) determining 100b the first information I-1, e.g., locally, e.g., within an apparatus 200 (FIG. 2) configured to perform at least one aspect of the method of the disclosure and/or within the wireless communication device 10.

In some examples, the first information I-1 may, e.g., be determined using a classifier, e.g., channel classifier, configured to determine the first information, e.g., by classifying at least one activity pattern associated with the wireless communication system 1, e.g., into quality classes, e.g., the quality categories mentioned above. In some examples, the further device 30 may represent or comprise such channel classifier. In some other examples, the apparatus 200 and/or the wireless communication device 10 may, e.g. comprise such channel classifier.

In some examples, the classifier 30 may determine a probability distribution PD-1, PD-2, PD-3, . . . of at least some, e.g., all, of the plurality PL-CH of channels for at least one, e.g., pre-defined and/or learned, quality category associated with the respective channel(s). In some examples, based on the respective probability distribution, a respective probability that a specific channel corresponds to a specific quality category may be determined.

In some examples, the classifier 30 may also be configured to determine a respective confidence CONF-1, CONF-2, CONF-3, . . . associated with the at least one quality category.

In some examples, the classifier 30 may, e.g., comprise a model based on artificial intelligence, e.g., machine learning.

In some examples, FIG. 1, performing 104 the channel switching may comprise: a) if the determination DET (see block 102 of FIG. 1) yields that channel switching should be performed, switching 104a a channel from a current channel CH to another channel CH′, or b) if the determining 102 yields that channel switching should not be performed, not switching, e.g., omitting to switch, e.g., refraining from switching, 104b, the current channel CH. Thus, in some cases, the current channel CH may further be used for the information exchange, e.g., if no further suitable channel CH′ is available.

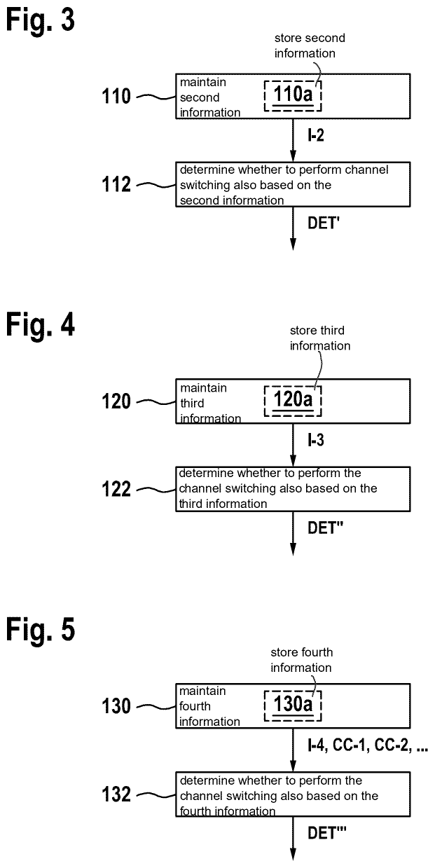

In some examples, FIG. 3, the method comprises: maintaining 110, e.g., storing 110a, second information I-2 characterizing historic channel switching decisions, e.g., of at least the device 10, performing 112 the determining 102 (FIG. 1) whether to perform channel switching also based on the second information I-2. In other words, in some examples, a determination DET′ whether to perform channel switching may be made based on at least one of the first information I-1 or the second information I-2. In some examples, this may, e.g., enable to prevent oscillatory behavior regarding channel switching.

In some examples, FIG. 4, the method comprises: maintaining 120, e.g., storing 120a, third information I-3 characterizing at least one threshold value characterizing at least one acceptable quality category, e.g., channel quality category, performing 122 the determining 102 (FIG. 1) whether to perform channel switching also based on the third information I-3. In other words, in some examples, a determination DET″ whether to perform channel switching may be made based on at least one of the first information I-1 or the second information I-2 or the third information I-3. In some examples, this enables to determine channels that are acceptable, e.g. for use as candidate for future channel switching.

In some examples, the at least one quality category, e.g., channel quality category, is associated with at least one performance indicator, for example key performance indicator, such as, e.g., a packet error rate, PER.

In some examples, FIG. 5, the method comprises: maintaining 130, e.g., storing 130a, fourth information I-4 characterizing a plurality of candidate channels CC-1, CC-2, . . . for the performing of the channel switching, performing 132 the determining 102 (FIG. 1) whether to perform channel switching also based on the fourth information I-4. In other words, in some examples, a determination DET′″ whether to perform channel switching may be made based on at least one of the first information I-1 or the second information I-2 or the third information I-3 or the fourth information I-4.

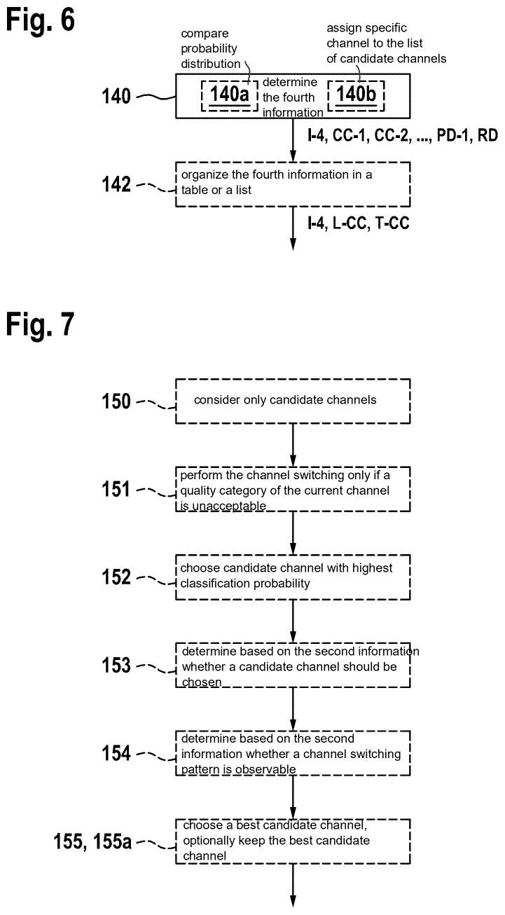

In some examples, FIG. 6, the method comprises: determining 140 the fourth information I-4, and, optionally, organizing 142 the fourth information I-4 in form of at least one of: a) a list L-CC, or b) a table T-CC.

In some examples, FIG. 6, the determining 140 of the fourth information I-4 comprises: comparing 140a the probability distribution PD-1 of a specific channel CC-1 with a predetermined reference distribution RD, e.g., a uniform distribution, assigning 140b the specific channel to the plurality, e.g., adding the specific channel CC-1 to the list L-CC, of candidate channels based on the comparison 140a, if the comparison 140a indicates that a difference between the probability distribution PD-1 of the specific channel and the predetermined reference distribution RD exceeds a predetermined threshold.

In some examples, FIG. 7, the method comprises at least one of: a) considering 150 candidate channels CC-1, CC-2, . . . , e.g., only candidate channels, for the performing 104, 104a of the channel switching, or b) performing 151 the channel switching only if a quality category, e.g., channel quality category, of a current channel CH is not acceptable, e.g., as compared to a predetermined threshold and if a candidate channel CC-1 with a better quality category is available, e.g., comprised by the fourth information I-4, e.g., comprised in the list L-CC and/or table T-CC, or c) choosing 152 a candidate channel CC-1 with a highest classification probability, e.g., if several candidate channels with a better quality category are available, or d) determining 153, e.g., based on the second information I-2, whether a candidate channel has been chosen for channel switching before, or e) determining 154, e.g., based on the second information I-2, whether a channel switching pattern is observable, e.g., for a predetermined number N, N>1, of preceding channels, or f) if a or the a channel switching pattern is observable, choosing 155 a best candidate channel of the observed channel switching pattern, and, optionally, keeping 155a the best candidate channel of the observed channel switching pattern, e.g., until a candidate channel that is not part of the observed channel switching pattern, becomes the best candidate channel.

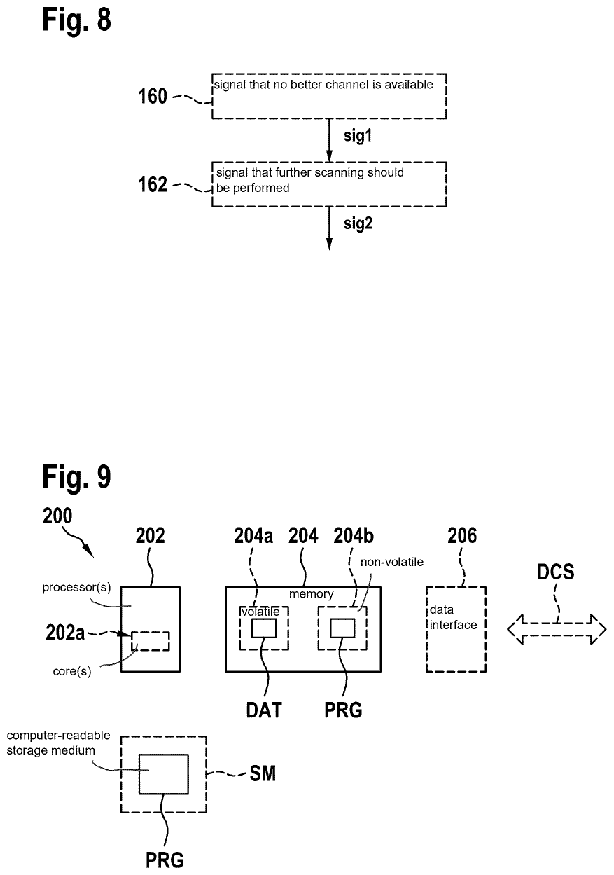

In some examples, FIG. 8, the method comprises at least one of: a) signaling 160, e.g., by transmitting a corresponding signal sig1, that no better channel is available, e.g., if all candidate channels CC-1, CC-2, . . . are worse than a current channel CH, or b) signaling 162, e.g., by transmitting a corresponding signal sig2, that, e.g., further, scanning, e.g., for potential candidate channels, should be performed, e.g., if, the current channel CH is not acceptable and/or if there are no candidate channels CC-1, CC-2, . . . for channel switching, e.g., if the list L-CC of candidate channels is empty.

In some examples, FIG. 8, at least one of the signaling 160 or the signaling 162 may, e.g., be performed by transmitting the corresponding signal sig1 and/or sig2, e.g., to a user, e.g., of the device 10.

Some examples, FIG. 9, relate to an apparatus 200 for a wireless communication device 10 (FIG. 1) that is configured to use at least one channel CH for information exchange IE with at least one further device 20, wherein the apparatus 200 is configured to perform the method according to the disclosure.

In some examples, FIG. 9, the apparatus 200 comprises at least one calculating unit, e.g. processor, 202 (comprising, e.g., at least one core 202a) and at least one memory unit 204 associated with (i.e., usable by) the at least one calculating unit 202 for at least temporarily storing a computer program PRG and/or data DAT, wherein the computer program PRG is e.g. configured to at least temporarily control an operation of at least one of the apparatus 200 or device 10, respectively, e.g. in the sense of an execution of a method according to the disclosure.

In some examples, FIG. 9, the at least one calculating unit 202 may comprise at least one of the following elements: a microprocessor, a microcontroller, a digital signal processor (DSP), a programmable logic element (e.g., FPGA, field programmable gate array), an ASIC (application specific integrated circuit), hardware circuitry, a tensor processor, a graphics processing unit (GPU). According to further examples, any combination of two or more of these elements is also possible.

In some examples, the memory unit 204 comprises at least one of the following elements: a volatile memory 204a, particularly a random-access memory (RAM), a non-volatile memory 204b, particularly a Flash-EEPROM.

In some examples, FIG. 9, the computer program PRG is at least temporarily stored in the non-volatile memory 204b. Data DAT (e.g. associated with at least one of the first information I-1 or the second information I-2 or the third information I-3 or the fourth information I-4 or the classifier 30), which may, e.g., be used for executing the method according to the disclosure, may at least temporarily be stored in the RAM 204a.

In some examples, FIG. 9, an optional computer-readable storage medium SM comprising instructions, e.g. in the form of the computer program PRG, may be provided. As an example, the storage medium SM may comprise or represent a digital storage medium such as a semiconductor memory device (e.g., solid state drive, SSD) and/or a magnetic storage medium such as a disk or harddisk drive (HDD) and/or an optical storage medium such as a compact disc (CD) or DVD (digital versatile disc) or the like.

In some examples, FIG. 9, the apparatus 200 may, e.g., comprise an optional data interface 206, e.g. for bidirectional data exchange with an external device (not shown). As an example, by means of the optional data interface 206, a data carrier signal DCS may be exchanged, e.g. with the external device, for example via a wired or a wireless data transmission medium (e.g., associated with the communication system 1), e.g. over a (virtual) private computer network and/or a public computer network such as, e.g., the Internet.

In some examples, FIG. 9, the data carrier signal DCS may represent or carry the computer program PRG according to the disclosure, or at least a part thereof.

Some examples, FIG. 2, relate to an access point 10a for a wireless communication system 1, e.g., a Wi-Fi-System, comprising at least one apparatus 200 according to the disclosure. In other words, in some examples, the device 10 may be a Wi-Fi access point.

Some examples, FIG. 2, relate to a client 20a for a wireless communication system 1, e.g., a Wi-Fi-System, comprising at least one apparatus 200 according to the disclosure. In other words, in some examples, the device 20 may be a Wi-Fi client.

Some examples, FIG. 2, relate to a wireless communication system 1, e.g., a Wi-Fi-System, comprising at least one of the following elements: a) an apparatus 200 according to the disclosure, or b) an access point 10a according to the disclosure, or c) a client 20a according to the disclosure.

Further aspects and examples are disclosed below, which may, in some examples, be combined with at least one of the aspects and examples explained above.

In some examples, FIG. 2, the principle according to the disclosure may enable to improve a channel switching procedure in wireless communication systems 1, such as, e.g., Wi-Fi systems.

In some examples, FIG. 2, the principle according to the disclosure may be used to provide a decision module, e.g., in the form of the apparatus 200, e.g., for channel switching systems, that make use of the first information I-1, as may, e.g., be provided and/or obtained by a classifier 30, e.g., channel classifier.

In other words, in some examples, principle according to the disclosure may be used to provide a decision module 100 that may use an output I-1 of a channel classifier 30, e.g., to improve the decisions of which channels a device 10, 10a, 20, 20a for a Wi-Fi system 1 should switch to. In some examples, this may improve a quality of service, QoS, that may be achieved with the Wi-Fi system 1 and may, e.g., enable one or more latency-critical applications APP (FIG. 2) to make use of Wi-Fi systems 1.

In some examples, the apparatus 200 may operate as or represent a module, e.g., decision module, that may consider both an expected channel quality, as, e.g., reflected by the quality category (see, for example, the first information I-1), but also the confidence of this classification associated with the quality category. Optionally, in some examples, a memory of past, e.g., historic, channel switching decisions, may be provided, e.g., enabling to prevent oscillatory behavior.

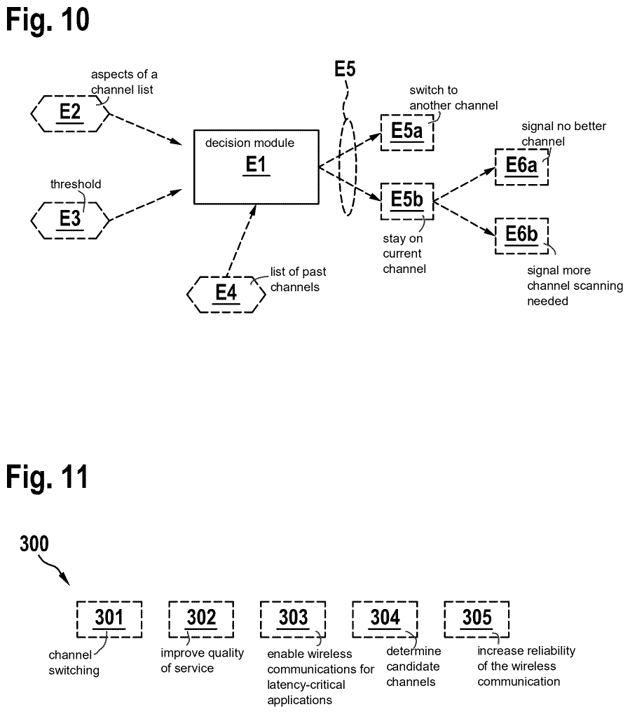

FIG. 10 schematically depicts a block diagram of a module, e.g., decision module, E1 according to some aspects of the disclosure. In some examples, at least some aspects of the configuration of FIG. 10, e.g., of the module E1, may, e.g., be implemented by means of the apparatus 200 according to the disclosure.

Element E2 of FIG. 10 symbolizes aspects of a channel quality list, CQL, e.g., comprising the first information I-1, e.g., organized in the form of a list. In some examples, the channel quality list E2 may, e.g., represent an input parameter to the module E1 and may, e.g., provide at least one probability distribution that classifies a channel as a certain quality category, e.g., channel quality category, with a certain probability, also see blocks PD-1, PD-2, . . . of FIG. 2.

Element E3 symbolizes a threshold that describes which channel quality categories are acceptable and which channel quality categories do not achieve one or more requirements, e.g., QoS requirements, of the application APP (FIG. 2) or of the Wi-Fi system 1, e.g., in general. In some examples, the channel quality categories may, e.g., be described by one or more, e.g., different, key performance indicators, KPIs, for example the PER, and thus, in some examples, the system's KPI requirements may, e.g., be checked, e.g., against the KPIs offered by the different channel quality categories. In some examples, one or more KPIs may be taken into account already in a classification process, wherein, e.g., the classifier 30 determines the first information, e.g., the channel quality categories.

In some examples, FIG. 10, a list E4 of past channels that the system 1 operated on may be provided, e.g., representing historic channel usage data.

In some examples, FIG. 10, based on at least some of the input information E2, E3, E4, the module E1 may provide a respective output information collectively denoted with reference sign E5. More specifically, in some examples, FIG. 10, the decision module E1 may either indicate, e.g., output, a switch to a certain, e.g., other, channel CH′, see block E5a, or it can also decide to stay on the current channel CH, see block E5b.

In the following, further aspects related to the decisions E5a, E5b according to some examples are described in detail.

In some examples, a candidate channel list L-CC (also see FIG. 6, block 142) is created as follows: In some examples, a channel may become a candidate channel if its classification, e.g., quality category, is deemed reliable enough. The reliability is, for example, defined as a distance of that channel's classification probability distribution PD-1 to a reference distribution RD, e.g., a uniform distribution. In some examples, a conventional measure to compare, e.g., assess a respective distance of, probability distributions may be used to determine the reliability. In some examples, e.g., if the distance is larger than a certain pre-defined threshold distance, the classification, e.g., quality category, may be deemed to be reliable. In some examples, the channel quality category may, e.g., be defined as a quality category that has a largest probability in the associated probability distribution PD-1.

In some examples, FIG. 10, the decision module E1 may, e.g., only, consider channels that are comprised in at least one of the channel quality list CQL or the candidate channel list L-CC.

In some examples, the channel is only switched if a current channel quality category is not acceptable (e.g., as defined by the channel quality category threshold) and if a better candidate channel (e.g., having a better channel quality category) is available. In some examples, e.g., if several better candidate channels, e.g., with a same quality category are available, the channel with the highest classification probability may be chosen.

In some examples, e.g., additionally, it may be checked whether a candidate channel has already been chosen before (e.g., based on the historic information, see element E4 of FIG. 10), and, e.g., if a pattern is observable in the past N channels, e.g., within the N many channels used in the past. In some examples, if a pattern is observed, the best channel of this pattern may be chosen and may be stayed on, e.g., until a channel that is not part of the observed pattern becomes the best candidate channel.

In some examples, FIG. 10, if the current channel CH is not acceptable and the channel is still not changed because all candidate channels are worse, a message E6a may be signaled, e.g., displayed, e.g., to a user, that states that no better channels than the current channel CH are available and therefore bad system performance may be expected. In some examples, FIG. 10, if the current channel CH is not acceptable and the channel is still not changed, e.g., because the candidate channel list is empty, a message E6b stating that more channel scanning is recommended and/or may be required may be signaled, e.g., displayed.

In some examples, FIG. 10, an output E5 of the decider E1 may, e.g., comprise at least one of the following aspects: a) Switch a channel, or b) do not switch the channel, or b1) the information that the switching decision could not be made as the input was not reliable enough, or b2) provide a message, e.g., to the user: b2a) that all channels are bad, or b2b) channel is good enough.

In some examples, FIG. 10, channel switching decisions of the module E1 may comprise at least one of the following aspects:
a) create candidate channel list, a1) a channel becomes a candidate if its classification (e.g., quality category) is deemed reliable enough, a2) reliability may be defined as a distance of that channel's classification probability distribution PD-1 to a uniform distribution RD, a2a) its distance should be larger than a threshold distance for the classification to be deemed reliable, b) switch to a channel if the current channel's class (e.g., quality category) is not acceptable AND a better candidate channel is available, b1) a channel's quality category may, e.g., be defined as that category that has the largest probability in the classification probability distribution PD-1, b2) if there are several candidates with the same most likely quality category, that candidate may be preferred that has the largest probability to be classified as that quality category.

Some examples, FIG. 11, relate to a use 300 of the method according to the disclosure and/or of the apparatus 200 according to the disclosure and/or of the access point 10a according to the disclosure and/or of the client 20a according to the disclosure and/or of the wireless communication system 1 according to the disclosure and/or of the computer program PRG according to the disclosure and/or of the computer-readable storage medium SM according to the disclosure and/or of the data carrier signal DCS according to the disclosure for at least one of the following elements: a) channel switching 301, or b) improving 302 a quality of service, or c) enabling 303 wireless communications, e.g., for latency-critical applications, or d) determining 304 candidate channels CC-1, CC-2, . . . , or e) increasing 305 a reliability of the wireless communication.

What is claimed is:

1. A computer-implemented method for a wireless communication device configured to use at least one channel for information exchange with at least one further device, comprising the following steps:
providing first information that characterizes, for each channel of a plurality of channels, a respective probability distribution of the channel for at least one quality category and a confidence associated with the at least one quality category;
determining whether to perform channel switching, from a current channel of the plurality of channels to another channel of the plurality of channels, based at least on the first information; and
performing channel switching based on the determining.

2. The method according to claim 1, wherein the providing of the first information includes at least one of:
a) receiving the first information from the at least one further device, or
b) determining the first information within an apparatus which includes the wireless communications device.

3. The method according to claim 1, wherein the performing of the channel switching includes:
a) when the determining of whether to perform the channel switching yields that the channel switching should be performed, switching from a current channel to the other channel, or
b) when the determining of whether to perform the channel switching yields that the channel switching should not be performed, refraining from switching from the current channel.

4. The method according to claim 1, further comprising:
storing second information characterizing historic channel switching decisions;
performing the determining of whether to perform the channel switching also based on the second information.

5. The method according to claim 1, comprising:
storing third information characterizing at least one threshold value characterizing at least one acceptable quality category; and
performing the determining of whether to perform the channel switching also based on the third information.

6. The method according to claim 1, wherein the at least one quality category is associated with at least one performance indicator.

7. The method according to claim 1, comprising:
storing fourth information characterizing a plurality of candidate channels for the performing of the channel switching; and
performing the determining of whether to perform the channel switching also based on the fourth information.

8. The method according to claim 7, further comprising:
determining the fourth information; and
organizing the fourth information in form of at least one of:
a) a list, or
b) a table.

9. The method according to claim 7, wherein the determining of the fourth information includes:
comparing the probability distribution of a specific channel with a predetermined reference distribution, and
assigning the specific channel to the plurality of candidate channels based on the comparison, when the comparison indicates that a difference between the probability distribution of the specific channel and the predetermined reference distribution exceeds a predetermined threshold.

10. The method according to claim 7, further comprising at least one of:
a) considering only candidate channels of the plurality of candidate channels for the performing of the channel switching, or
b) performing the channel switching only when a quality category of the current channel is not acceptable as compared to a predetermined threshold, and when a candidate channel of the plurality of candidate channels with a better quality category is available, or
c) choosing a candidate channel of the plurality of candidate channels with a highest classification probability when several candidate channels of the plurality of candidate channels with a better quality category are available, or
d) determining whether the candidate channel of the plurality of candidate channels has been chosen for channel switching before, or
e) determining whether a channel switching pattern is observable for a predetermined number N, N>1, of preceding channels of the plurality of channels, or
f) when the channel switching pattern is observable, choosing a best candidate channel of plurality of channels of the observed channel switching pattern, and keeping the best candidate channel of the observed channel switching pattern until a candidate channel of the plurality of candidate channels that is not part of the observed channel switching pattern, becomes the best candidate channel.

11. The method according to claim 10, further comprising at least one of:
a) signaling that no better channel is available, when all candidate channels of the plurality of candidate channels are worse than the current channel, or
b) signaling that further scanning for potential candidate channels should be performed: when the current channel is not acceptable and/or when there are no candidate channels for channel switching.

12. An apparatus for a wireless communication device that is configured to use at least one channel for information exchange with at least one further device, wherein the apparatus is configured to:
provide first information that characterizes, for each channel of a plurality of channels, a respective probability distribution of the channel for at least one quality category and a confidence associated with the at least one quality category;
determine whether to perform channel switching, from a current channel of the plurality of channels to another channel of the plurality of channels, based at least on the first information; and
perform channel switching based on the determining.

13. An access point for a wireless communication system, the access point, comprising:
at least one apparatus for a wireless communication device that is configured to use at least one channel for information exchange with at least one further device, wherein the at least one apparatus is configured to:
provide first information that characterizes, for each channel of a plurality of channels, a respective probability distribution of the channel for at least one quality category and a confidence associated with the at least one quality category,
determine whether to perform channel switching, from a current channel of the plurality of channels to another channel of the plurality of channels, based at least on the first information, and
perform channel switching based on the determining.

14. A client for a wireless communication system, comprising at least one apparatus for a wireless communication device that is configured to use at least one channel for information exchange with at least one further device, wherein the at least one apparatus is configured to:
provide first information that characterizes, for each channel of a plurality of channels, a respective probability distribution of the channel for at least one quality category and a confidence associated with the at least one quality category,
determine whether to perform channel switching, from a current channel of the plurality of channels to another channel of the plurality of channels, based at least on the first information, and
perform channel switching based on the determining.

15. A non-transitory computer-readable storage medium on which are stored instructions for a wireless communication device configured to use at least one channel for information exchange with at least one further device, the instructions, when executed by a computer, causing the computer to perform the following steps:
providing first information that characterizes, for each channel of a plurality of channels, a respective probability distribution of the channel for at least one quality category and a confidence associated with the at least one quality category;
determining whether to perform channel switching, from a current channel of the plurality of channels to another channel of the plurality of channels, based at least on the first information; and
performing channel switching based on the determining.

16. The method according to claim 1, wherein the method is used for at least one of the following elements:
a) channel switching, or
b) improving a quality of service, or
c) enabling wireless communications for latency-critical applications, or
d) determining candidate channels, or
e) increasing a reliability of the wireless communication.
